(19) United States
(12) Patent Application Publication
(10) Pub. No.: US 2026/0217005 A1
(43) Pub. Date: Jul. 30, 2026

(54) Method for Producing a Laminate Comprising at Least One Kraft Paper Layer and at Least One Other Paper Layer

(71) Applicant: SWISS KRONO Tec AC, Luzern (CH)

(72) Inventor: Norbert Kalwa, Horn-Bad Meinberg (DE)

(21) Appl. No.: 19/145,008

(22) PCT Filed: Dec. 13, 2023
(86) PCT No.: PCT/EP2023/085638

§ 371 Date: Jul. 1, 2025

(30) Foreign Application Priority Data
Jan. 2, 2023 (EP) 23150044.8

(51) Int. Cl. B32B 27/10; B32B 27/18; B32B 27/42; B32B 37/10

(52) U.S. Cl. CPC B32B 27/10; B32B 27/18; B32B 27/42; B32B 37/1027; B32B 2307/3065; B32B 2307/412; B32B 2307/718

(57) ABSTRACT

It is provided a method for producing a laminate including at least one kraft paper layer, including providing at least one raw kraft paper layer, —applying at least a first layer of at least one powdery resin to at least one side of the kraft paper layer, placing at least one further paper layer on the side of the kraft paper layer sprinkled with the powdery resin, and pressing the layered structure.

### CROSS-REFERENCE TO RELATED APPLICATIONS

This application is the United States national phase of International Patent Application No. PCT/EP2023/085638 filed Dec. 13, 2023, and claims priority to European Patent Application No. 23150044.8 filed Jan. 2, 2023, the disclosures of each of which are hereby incorporated by reference in their entireties.

### BACKGROUND

### Technical Field

The present disclosure relates to a method for producing a laminate comprising at least one kraft paper layer and at least one further paper layer and laminates producible by this process.

### Technical Considerations

Laminates are laminates made of paper impregnates pressed together and applied (laminated) to carrier boards. Currently known in the state of the art are, for example, laminates in which the laminate comprises at least one impregnated paper layer, such as a decorative impregnate, at least one transparent paper layer (glassine), e.g. glassine treated with sulphuric acid, and/or at least one plastic film layer.

A distinction is made between High Pressure Laminate (HPL) and Continuous Pressure Laminate (CPL). HPL is a laminate produced in the high-pressure pressing process in panel form from several layers of paper and resin, which is produced in a multi-daylight press. CPL is produced in a continuous process from several layers of paper and resin. It is usually available in rolls and is used, for example, to produce worktops, wrapped profiles and door panels. CPL is pressed in a continuous or endless process in double-sided heated roller belt presses. In both HPL and CPL, kraft papers are used as at least one paper layer. Kraft papers have a high strength with a weight of up to 200 g/m² and consist of cellulose fibers to which starch, alum and glue are added in order to achieve surface effects and increased strength.

In the production of CPL on double belt presses, resin-impregnated kraft paper layers in the form of soda kraft paper (NKP) are used in the core layer, just as for HPL. While phenolic resin-impregnated NKP is usually used for HPL, NKP with a mixture of melamine and phenolic resin is generally used for CPL. The resin application for HPL kraft papers in the core layers is usually 40-50% by weight. For CPL core layers, it is 80-90% by weight.

The kraft papers are impregnated on impregnation channels, some of which are operated at speeds of >100 m/min. While impregnates for HPL are produced on the basis of kraft papers as sheets, impregnates for CPL are produced on the basis of kraft papers as rolls. This also applies to the other impregnates used on a CPL system (decor, overlay or backing impregnates). Only in exceptional cases is sheet material used.

As the rolls can be several hundred meters long, depending on the weight of the paper, they represent a considerable value of goods. During the production of the rolls, however, quality can only be determined at the end of the roll (final weight, resin application, moisture content). However, this says nothing about the resin application and the moisture in the roll. Fluctuations in the process (temperature of the impregnating resins and NKP, temperature in the production hall, temperature fluctuations in the drying channel, etc.) or in the raw material (grammage, paper moisture, etc.) can lead to impregnated rolls that cause problems on the CPL system. These can include delamination, warping, etc. It would be possible to monitor the process by installing on-line analytics (near-infrared spectroscopy, microwave, etc.). However, the problem remains that, due to the high production speeds, large quantities of qualitatively imperfect impregnate are still produced, as there are still minutes of production time between detection and correction.

In addition, many CPL manufacturers do not produce the impregnated kraft paper layers used in core layers themselves, as a high-speed impregnation channel usually has significantly more impregnation capacity than can be processed on one or two CPL systems. For reasons of contamination, however, decorative papers or overlays cannot be impregnated with melamine resins on an impregnation channel on which phenolic resins are processed. This is not possible even after extensive cleaning of the channels. A CPL manufacturer is therefore dependent on the impregnation qualities of the kraft paper layers available on the market. If these lead to problems on his system, he only has the option of remedying the defects by changing the system parameters (temperature, system speed and pressure). A particularly negative aspect is that impregnates are usually supplied by full trucks. This means that the producer has a large quantity of rolls in stock, which can only be checked for their suitability for use in production on a “trail and error” basis.

Furthermore, it is often a problem to create certain product properties by adding additives to the impregnation baths. In some cases, the additives are poorly soluble in water, while in others the addition leads to segregation in the impregnation tank. This complicates the impregnation process and makes it difficult or even impossible to achieve the desired properties.

Furthermore, the entire width of the fabric web is always impregnated during impregnation. This can later lead to soiling of the press belts/structurizers on the CPL system under pressure and temperature due to resin escaping at the edges. An attempt is made to solve this problem by applying solvent to the edges in front of the impregnation tank. However, the quantity and positioning of the nozzle must be monitored. In addition, the time between application and immersion in the impregnation tank is relatively short due to the high speed, so that good impregnation of the edge area is not achieved.

There are various disadvantages. For example, it is difficult to determine the quality in the roll and to change the property profile. Impregnation of the edge area is also problematic and water-insoluble additives cannot be used for impregnation.

### SUMMARY OF THE INVENTION

The present solution is therefore based on the technical object of remedying the deficiencies described above. For example, it is desirable to provide an approach to carry out the impregnation of kraft paper layers directly on site at the CPL manufacturer and thus not to be dependent on the supply of already impregnated kraft paper layers with the disadvantages described above. This should also take into account the low requirements of a single CPL plant. It should also be possible to adjust the impregnated kraft paper layers quickly and precisely with regard to resin application, moisture or other parameters. Furthermore, the addition of additives to achieve resin/product properties should also be easily possible. It should also be possible to use powdery/fibrous fillers (cellulose, flours, inorganic and organic fibers, etc.). It should also be possible to quickly adapt to different web widths and avoid material losses.

### DETAILED DESCRIPTION

This object is solved by a method with features as described herein.

Accordingly, a method for producing a laminate, for example a CPL, comprising at least one kraft paper layer is provided, the method comprising:
Providing at least one non-impregnated or raw kraft paper layer,
Applying at least a first layer of at least one powdered resin to at least one side of the kraft paper layer,
Placing at least one further layer of paper on the side of the kraft paper layer sprinkled with the powdered resin, and
Pressing the layer structure.

Accordingly, a multi-stage process is provided in which resin powder is applied to a non-impregnated or raw kraft paper layer immediately upstream of a CPL system.

A non-impregnated or raw kraft paper layer means a kraft paper layer weighing up to 200 g/m² that is not impregnated with an impregnating resin, for example a formaldehyde resin such as melamine, urea and phenol formaldehyde resin, or other resins such as melamine ether resins, acrylic resins, epoxy resins and thus consists solely of cellulose fibers.

The spreading of resin powder on a raw, non-impregnated kraft paper layer according to the present disclosure and the subsequent pressing with a further paper layer at temperatures of up to 200° C. causes the resin powder to melt. The melted resin powder penetrates at least partially into the raw kraft paper layer and, if necessary, into the further paper layer and causes a corresponding impregnation.

As will be explained in detail later, a further kraft paper layer, a decorative paper layer or an overlay paper layer can be used as additional paper layers that are placed on top of the sprinkled raw kraft paper layer.

As also explained below, a decor paper is typically understood to be a paper impregnated with a resin and printed with a decor. An overlay paper is a paper impregnated with a resin and equipped with abrasion-resistant particles. The usual impregnating resins used for this purpose are melamine-formaldehyde resins, which are typically present as precondensates after impregnation. The low-molecular precondensates still have free methylol groups and a low degree of cross-linking and are therefore an intermediate polymerization product. This state of the condensation resin in liquid-impregnated paper layers is also defined as state B of the resin or condensate.

As indicated, the aim of the present method is not to use kraft paper already impregnated for laminate production, as is usually the case, but to sprinkle it with dry powdered resin as raw paper and only directly in front of a high-pressure press.

Together with the other named paper layers, for example a covering kraft paper, a decorative paper (impregnate) and an overlay paper (impregnate), such a stack is pressed under high pressure and high temperature so that the resins first liquefy and then condense, thus forming a laminate. During the condensation step, the curable precondensates (state B) contained in the impregnates are converted into cured polycondensates (state C) by splitting off the methylol groups still present. Such high-pressure laminates are then applied to various substrates, usually glued on.

As will be described in detail later, the resin powder can be applied to the raw kraft paper layer by spreaders that spread the resin or resin mixture onto the raw kraft paper with or without additives. The spreading quantities can be changed/adjusted within minutes by changing the rotation speed. The spreader can be adjusted so that there are no resins in the edge areas. It is also easy to change the spreading width from e.g. 1340 mm to 2070 mm. Furthermore, a desired property can be achieved by adding additives (flame retardants, agents to increase conductivity, color pigments, etc.). A key point here is that a spreader can spread very precisely (+/−1% across the web width). It is also possible to react upwards or downwards in the event of emerging quality problems or changes in the application quantity. In addition, the ratio between the phenolic resin and the melamine resin powder can be quickly adjusted to the process. The same applies to the addition of additives. If different characteristics are required, this can be quickly adjusted on the mixing device. Of course, other products available in sheet form that cause problems during impregnation can also be used. These problems can consist in the precise adjustment of the resin application, the impregnation or the handling on the impregnation line, etc. This process can also be used with pre-products that are not available as web products or whose production as web products is uneconomical. These can be glass fleeces, graphite-containing papers, plastic foils, aluminum foil or veneers. As only relatively thin products are usually produced on a CPL system (thickness <1.0 mm), which means that two or three raw kraft paper layers are used, two spreaders are sufficient for production. Of course, pure melamine resin can also be applied to the top raw kraft paper (e.g. NKP) so that a further layer of paper (such as decorative paper) can be applied on top without impregnation. As the powders contain little to no moisture, the desired moisture content can be set by vaporizing the NKP in front of the spreaders.

The present process therefore offers various advantages. For example, the laminate production process can be designed flexibly. The order quantity can be adjusted quickly. Cost savings are possible due to low fluctuation in the process. The present process also eliminates several work steps that are required in conventional liquid impregnation, such as passing the paper layer through an impregnation bath and subsequent drying.

It should also be emphasized that the step of applying the resin powder to a kraft paper layer is preferably integrated into a continuous CPL production line; i.e. the step of applying the resin powder is preferably carried out on a moving kraft paper layer.

The spreading of powder in the production of multilayer boards or panels is known in various combinations. According to EP 3144449B1, for example, a powder mixture of thermosetting resins and wood or stone particles is sprinkled onto a carrier board made of compacted wood wool. U.S. Ser. No. 10,513,094 B2 describes the scattering of a powdery mixture of particles of waste paper and a binder onto a wood-based panel, such as MDF, HDF. In each of these cases, the spreading of powder mixtures onto compact carrier boards is described.

The kraft paper layers used in the present case have a weight of 50 to 200 g/m², preferably of 80 to 170 g/m², particularly preferably of 80 to 160 g/m², such as 80 g/m², 120 g/m² or 160 g/m². As already mentioned above, kraft papers have a high strength and consist of cellulose fibers to which starch, alum and glue are added in order to achieve surface effects and increases in strength.

In a further non-limiting variant of the present method, the surface or side of the raw kraft paper layer to be sprinkled with the powdered resin is pretreated prior to the sprinkling of the powdered resin to improve the adhesion of the powdered resin to the surface of the raw kraft paper layer.

This pre-treatment can include exposing the side or surface to moisture or electrostatically charging the side or surface of the kraft paper layer.

Accordingly, in one non-limiting embodiment of the present method, the at least one raw kraft paper layer is moistened before sprinkling with the powdered resin. For moistening, water is applied to a kraft paper layer in an amount of 10 g water/m² to 40 g water/m², e.g. of 10 to 20 g water/m², of 15 to 30 g water/m² and/or of 20 to 40 g water/m².

The amount of water applied/sprayed on varies depending on the paper weight (grammage) and the moisture content of the kraft paper used. For example, for kraft paper with a paper weight of 80 to 100 g/m², the amount of water sprayed on can be of 10 to 20 g water/m², for kraft paper with a paper weight of 110 to 130 g/m², the amount of water sprayed on can be of 15 to 30 g water/m², and for kraft paper with a paper weight of 150 to 170 g/m², the amount of water sprayed on can be of 20 to 40 g water/m².

Another option is to fix the powder to the kraft paper layer using electrostatic charging. The powder can be electrostatically charged and applied to the kraft paper layer. There is a counter electrode underneath the paper web, which ensures good fixation on the paper.

In one non-limiting embodiment of the present method, the powdered resin to be applied is a formaldehyde resin, preferably a melamine-formaldehyde resin or a phenol-formaldehyde resin or a mixture of a melamine-formaldehyde resin and a phenol-formaldehyde resin. If a mixture of phenol-formaldehyde resin and melamine-formaldehyde resin is used, the ratio of the two resins is 4:1, preferably 3:2. The two resins are preferably mixed in a mixing device before they are spread on the kraft paper layer.

The particle size of the powdered resin is of 20 to 100 μm, preferably of 40 to 80 μm.

In one non-limiting embodiment of the present process, the powdered resin or resin mixture is applied to the at least one kraft paper layer in an amount of 50 to 350 g/m², preferably of 100 to 300 g/m², more preferably of 120 to 280 g/m², most preferably of 150 to 250 g/m².

The powdered resin is preferably applied using at least one scattering device. The number of scattering devices upstream of the CPL system can be flexibly adjusted. Spreading is preferably carried out in a continuous throughput process. A suitable spreading device is the precision spreader “Oscillating Brushing System” from TPS. However, electrostatic application with a tribo gun is also possible.

The spreading width of the spreader can also be adjusted as required. For example, it is advantageous if the edge areas of the kraft paper layers (e.g. the outer two centimetres) are not sprinkled with resin, which can prevent the resin from escaping during subsequent pressing.

The spreading density is selected so that the resin application is of 70 to 90% by weight, preferably of 75 to 85% by weight in relation to two kraft paper layers, e.g. 75% by weight, 77% by weight or 85% by weight.

As already mentioned, at least one further layer of paper is placed on top of the layer of kraft paper sprinkled with the resin powder. Any number of paper layers can be applied, although two, three or four additional paper layers are preferred.

As mentioned above, the at least one further paper layer to be applied can be a kraft paper layer, a decorative paper layer or an overlay paper layer.

Preferably, a further layer of kraft paper is applied, which is also not impregnated, i.e. is in its raw state.

The further kraft paper layer is followed by an (impregnated) decorative paper layer and/or (impregnated) overlay paper layer. The possible layer or cover structures are described in detail below. It is also conceivable that a raw decor paper layer is used.

As mentioned, the decorative and overlay paper layers used can be completely impregnated with a resin, preferably melamine-formaldehyde resin. In the case of a completely impregnated paper, a resin quantity of 80 to 400% by weight, preferably of 90 to 120% by weight, particularly preferably of 100 to 110% by weight is applied in relation to the paper weight of the paper.

Overlay papers are thin papers that have typically already been impregnated with a conventional melamine resin. Overlay papers are also available in which abrasion-resistant particles, such as corundum particles, are already mixed into the resin of the overlay or sprinkled onto the resin-wetted overlay to increase abrasion resistance. Resin applications with up to 400% melamine resin by weight are used for the impregnation of overlay papers. For most applications (laminates for worktops or payment counters), overlays without corundum are sufficient,

Decor papers are specialty papers for surface finishing of wood-based materials that allow for a wide variety of decors. In addition to the typical imprints of various wood structures, further imprints of geometric shapes or artistic products are available. There is virtually no restriction in the choice of motif. To ensure optimum printability, the paper used must have a suitable smoothness and dimensional stability and also be suitable for the penetration of any necessary synthetic resin impregnation. The resin application rate for decorative impregnates is 100 to 120% by weight.

In a further non-limiting embodiment, it is provided that at least one layer of a coating material is first applied to the side of the raw kraft paper layer sprinkled with the powdered resin, followed by at least one of the further paper layers. It is also possible to sprinkle resin powder on the material layer before the at least one further paper layer is placed on the material layer.

In one non-limiting variant, a material layer (e.g. glass fleece) is placed on the side of the kraft paper layer sprinkled with the resin powder, followed by a second kraft paper layer, a decorative paper layer and/or an overlay paper layer. In a further non-limiting variant, it is provided that a material layer (e.g. aluminum foil) is placed on the side of the kraft paper layer sprinkled with the resin powder, onto which resin powder is also sprinkled, followed by a second kraft paper layer, a decorative paper layer and/or an overlay paper layer.

However, it is also possible to omit a second kraft paper layer and/or decorative paper layer and apply an overlay paper layer directly to the material layer. The type and sequence of the additional paper layers applied can be flexibly designed depending on the type of porous material layer. If the porous material layer is colored, for example, a decorative paper can be omitted.

The at least one coating material can be selected from the following materials: a veneer layer, graphite-containing papers to increase conductivity, plastic films, for example thermoplastic films (enable tight postforming radii), aluminum foil, non-woven material and other fabric materials. The coating materials used can either be porous or non-porous, i.e. impermeable to liquids. For example, materials are included which have a porosity in which liquid resin can rise during pressing and which are at least partially plastically deformable.

The use of a glass fleece serves to improve the impact resistance. By using glass fleece, an impact resistance of 25 to 25 N, preferably of 28 to 32 N, e.g. 29 N, can be achieved even with thin laminates (<1 mm).

The use of aluminum foils, which are preferably provided with a primer, e.g. isocyanate primer, before application, reduces the water vapor permeability. The thickness of the aluminum foils is of 0.1 to 0.3 mm, preferably 0.2 mm.

If a veneer layer is used, in one non-limiting embodiment this comprises at least one layer of real wood veneer.

In a further non-limiting embodiment, the at least one veneer comprises at least one layer of real wood with a thickness of 0.2 to 10 mm, preferably of 0.5 to 5 mm, particularly preferably of 0.5 to 2 mm. The veneer can be produced in one piece from a log, for example by peeling. However, it can also be composed of individual pieces that are joined together, for example, by binders or so-called glue threads. The veneer preferably has the dimensions of the carrier board. The veneer has an underside facing the carrier board and an upper side facing away from the carrier board.

In a further non-limiting embodiment of the present method, the layered structure comprising a kraft paper layer and at least one further paper layer is pressed with at least one structuring paper (placed on the at least one further paper layer on the upper side of the layering) and at least one transparent paper (on the lower side of the layering).

A structuring paper is a paper that gives the surface of the laminate a structure (e.g. 3D structure) after it has been applied and pressed. In addition to its structuring function, the structuring paper also has a protective function, particularly during the pressing step. The structuring paper is removed again after the laminate or top layer has been pressed and can be recycled.

The transparent paper used in this laminate is also known as pergamin. Pergamin is a transparent paper made from finely ground cellulose that is largely greaseproof but not wet-strength. It gets its high transparency from a very sharp satin finish.

It is also possible to use non-impregnated paper on the underside. If only about half of the powdered resin is used for this paper, there is no need to sand the laminate on the reverse side after pressing.

It is also conceivable to apply an additional backing paper to the underside of the layer structure to stabilize the laminate. Backing papers are high-quality, impregnated papers for use as backing material, e.g. for single-sided surface veneers and other single-sided coatings.

In a further non-limiting embodiment of the present process, an additive, for example a flame retardant, is added to the powdered resin.

Acetoguanamine, ammonium polyphosphate, tris(tri-bromoneopentyl) phosphate, for example, can be used as flame retardants. The ratio of flame retardant to resin powder is preferably of 1.5 to 5.

In a further non-limiting variant of the present method, the layered structure comprising the side of the kraft paper layer sprinkled with the powdered resin, possibly at least one porous material layer, at least one further paper layer, for example a kraft paper layer, decorative paper layer and/or overlay paper layer, possibly a structuring paper, possibly a transparent paper and possibly a backing paper is pressed in a hot press, for example in a continuous press or in a double belt press.

The pressing step in the press (CPL press) is carried out at an applied pressing pressure of 50 to 70 kg/cm² and a temperature of 150 to 200° C., preferably 180° C. The speed of the pressing system is of 5 to 20 m/min, preferably of 5 to 15 m/min, e.g. 9.5 m/min. The laminate produced in the press has a thickness of 0.15 to 1.2 mm.

The present method makes it possible to provide a laminate (or deck), for example a CPL, which has at least one resin-impregnated kraft paper layer as a core layer and further paper layers, for example kraft paper layer, decorative paper layer and/or overlay paper layer.

In one non-limiting variant, the laminate comprises at least one overlay paper layer, at least one decor paper layer and at least two kraft paper layers. Such a layer structure can look as follows from top to bottom: Overlay paper layer, a decor paper layer, a first kraft paper layer and a second kraft paper layer.

In another non-limiting variant, the laminate comprises at least one overlay paper layer, at least one decorative paper layer, at least two kraft paper layers and at least one transparent paper. Optionally, at least one backing may be provided. Such a layer structure can look as follows from top to bottom: Overlay paper layer, a decor paper layer, a first kraft paper layer and a second kraft paper layer and a transparency paper (pergamin layer).

In a further non-limiting variant, the laminate comprises at least one structuring paper, at least one overlay paper layer, at least one decorative paper layer, at least two kraft paper layers and at least one transparent paper. Optionally, at least one backing can be provided. Such a layer structure can look as follows from top to bottom: structuring paper, overlay paper layer, a decor paper layer, a first kraft paper layer and a second kraft paper layer and a transparency paper (pergamin layer).

In a further non-limiting variant, the laminate which can be produced using the present method comprises, if appropriate, at least one structuring paper, at least one overlay paper layer, at least one decorative paper layer, at least two kraft paper layers and at least one transparent paper, at least one flame retardant being provided between the two kraft paper layers

In an even further non-limiting variant, the laminate that can be produced using the present method may comprise at least one structuring paper, at least one overlay paper layer, at least one decorative paper layer, at least two kraft paper layers, at least one layer of a (porous) coating material, for example glass fleece or aluminum foil, and at least one transparent paper. Optionally, at least one backing may be provided. Such a layer structure can look as follows from top to bottom: if necessary, a structuring paper, an overlay paper layer, a decorative paper layer, a first kraft paper layer, a layer of a coating material, for example glass fleece or aluminum foil, and a second kraft paper layer and a transparent paper (pergamin layer).

In a still further non-limiting variant, the laminate which can be produced using the present method optionally comprises at least one structuring paper, at least one overlay paper layer, at least one kraft paper layer, at least one layer of a (porous) coating material, for example a veneer, and at least one transparent paper. Optionally, at least one backing can be provided. Such a layer structure can look as follows from top to bottom: if necessary, a structuring paper, an overlay paper layer, a layer of a (porous) coating material, for example a veneer, a kraft paper layer and a transparent paper (glassine layer).

The backing mentioned in the above non-limiting embodiments of the laminate is taken up when necessary.

The present laminate or deck has a thickness of 0.1 to 3 mm, preferably of 0.1 to 1.2 mm.

The present disclosure is explained in more detail below using several examples.

For the following examples, the powder resins BASF 630 (melamine resin) and Prefere 82 8583G0 (phenolic resin) were used.

### Example 1

An 80 g/m² NKP (width: 1340 mm) was unwound from a roll on a CPL system. Approx. 10 g water/m² was sprayed onto the kraft paper (top side) with the aid of a moistening system.

A mixture of phenolic and melamine resin was spread onto the NKP immediately before the press. The ratio between phenolic and melamine resin was 3 to 2. The resins were mixed in a mixing device and then fed to the spreading device. The application quantity was 136 g resin mixture/m 2 (resin application: 85% based on two NKP).

The spreader was adjusted so that the web was not sprinkled with resin powder on the outer two centimetres on both sides. A second NKP layer of the same grammage was applied to the kraft paper via an unwind. A decorative impregnate and an overlay impregnate were then applied with the usual resin and moisture content.

This structure was created with a structure paper on the upper side and a pergamin (60 g/m²) on the underside was fed through the system at a speed of 9.5 m/min. The pressing temperature was 180° C., the pressing pressure 60 kg/cm². No resin leakage was observed at the edge behind the press. The resulting laminate was trimmed and rolled up.

The laminate was then tested in accordance with DIN EN 438 in comparison with a laminate produced with impregnated NKP for a number of important parameters (water vapor test, postforming properties, scratch test). No differences were found between the two laminates.

### Example 2

NKP in grammages of 80, 120 and 160 g/m² (width: 1340 mm) were unwound from a roll on a CPL system. With the help of a moistening system, approx. of 10 to 20 g water/m² (80 g NKP), of 15 to 30 g water/m² (120 g NKP) and of 20 to 40 g water/m² (160 g NKP) were sprayed onto the top surface.

A mixture of phenolic and melamine resin was spread onto the NKP immediately before the press. The ratio between phenolic and melamine resin was 3 to 2. The resins were mixed in a mixing device and then fed to the spreading device. The application quantities were 136 g (80 g/m²), 204 g (120 g/m²) and 272 g (160 g/m²) resin mixture/m² (resin application: 85% based on two NCPs).

The spreader was adjusted so that the web was not sprinkled with resin powder on the outer two centimetres on both sides. A second NKP layer of the same grammage was applied to the kraft paper via an unwind. A decorative impregnate and an overlay impregnate were then applied with the usual resin and moisture content.

This structure was run through the system at a speed of 9.5 m/min with a structuring paper on the upper side and a pergamin (60 g/m²) on the underside. The pressing temperature was 180° C., the pressing pressure 60 kg/cm². No resin leakage was observed at the edge behind the press. The resulting laminate was trimmed and rolled up.

The laminates were then tested in accordance with DIN EN 438, Part 2, “12. Resistance to immersion in boiling water”. The focus was on the assessment of delamination due to poor resin distribution/resin penetration. The results are shown in Table 1. In the case of a laminate with resinated NCP produced after the normal impregnation process, neither blistering nor delamination is usually detected in the “Storage in boiling water” test.

TABLE 1

Sample

| | NKP 80 | NKP 120 | NKP160 |
|---|---|---|---|
| Examination | g/m² | g/m² | g/m² |
| Resistance to immersion | | | |
| In boiling water | | | |
| Delamination | o.B. | o.B. | o.B. |
| Bubble formation | o.B. | o.B. | o.B. |
| Mass increase in % | 8.5 | 7.75 | 6.5 |

### Example 3

NKP in grammages of 80, 120 and 160 g/m² (width: 1340 mm) were unwound from a roll on a CPL system. A moistening system was used to spray approx. of 10 to 20 g water/m² onto the kraft paper (top side).

A mixture of phenolic and melamine resin was spread onto the NKP immediately before the press. The ratio between phenolic and melamine resin was 3 to 2. The resins were mixed in a mixing device and then fed to the spreading device. The application quantities were 122 g (80 g/m²), 180 g (120 g/m²) and 245 g (160 g/m²) resin mixture/m² (resin application: 77% based on two NCPs).

The spreader was adjusted so that the web was not sprinkled with resin powder on the outer two centimetres on both sides. A second NKP layer of the same grammage was applied to the kraft paper via an unwind. A decorative impregnate and an overlay impregnate were then applied with the usual resin and moisture content.

This structure was run through the system at a speed of 9.5 m/min with a structuring paper on the upper side and a pergamin (60 g/m²) on the underside. The pressing temperature was 180° C., the pressing pressure 60 kg/cm². No resin leakage was observed at the edge behind the press. The resulting laminate was trimmed and rolled up.

The laminates were then tested in accordance with DIN EN 438, Part 2, “12. Resistance to immersion in boiling water”. The focus was on the assessment of delamination due to poor resin distribution/resin penetration. The results are shown in Table 2. In the case of a laminate with resinated NCP produced after the normal impregnation process, neither blistering nor delamination is usually detected during the “storage in boiling water” test.

TABLE 2

Sample

| | NKP 80 | NKP 120 | NKP160 |
|---|---|---|---|
| Examination | g/m² | g/m² | g/m² |
| Resistance to immersion | | | |
| In boiling water | | | |
| Delamination | o.B. | o.B. | o.B. |
| Bubble formation | o.B. | o.B. | o.B. |
| Mass increase in % | 7.7 | 6.9 | 6.8 |

As can be seen from the results, the resin application can be reduced by 10% without any noticeable loss of quality. Surprisingly, the increase in mass of the impregnates with less resin application is lower than for the laminates with higher resin application.

### Example 4

A 165 g/m² NKP (width 1340 mm) was unwound from a roll on a CPL system. With the help of a moistening system, approx. of 20 to 40 g water/m² was sprayed onto the kraft paper (top side).

Immediately before the press, a mixture of flame retardant (acetoguanamine), phenolic and melamine resin was spread on the NCP. The ratio between guanamine, phenolic and melamine resin was 1.5 to 3 to 2. The application quantity was 316 g resin+flame retardant/m² (resin application: 75% based on two NCPs).

The spreader was adjusted so that the outer 2 cm of the web was not sprinkled with resin powder. A second NKP layer of the same grammage was applied to the kraft paper via an unwind. A decorative impregnate and an overlay impregnate were then applied with the usual resin and moisture content.

This structure was run through the system at a speed of 9.5 m/min with a structuring paper on the upper side and a pergamin (60 g/m²) on the underside. The pressing temperature was 180° C. and the pressing pressure was 60 kg/cm².

The resulting laminate was rolled up. The laminate was then tested in accordance with DIN EN 13 501-1:2018 (classification of fire behavior). The result was c-s1, do is achieved.

### Example 5

An 80 g/m² NKP (width: 1340 mm) was unwound from a roll on a CPL system. With the help of a moistening system, approx. 10 g water/m² was sprayed onto the kraft paper (top side). Immediately before the press, a mixture of phenolic and melamine resin was sprinkled onto the NKP.

The ratio between phenolic and melamine resin was 3 to 2. The resins were mixed in a mixing device and then fed to the spreading device. The application quantity was 136 g resin mixture/m 2 (resin application: 85% based on two NKP).

The spreader was adjusted so that the outer two centimetres of the web were not sprinkled with resin powder on both sides. A glass fleece (grammage: 110 g/m²) was unrolled onto the kraft paper and 136 g/m² resin was also sprinkled on top. The glass fleece was used to improve the impact resistance. A second NKP layer of the same grammage was applied to the fleece via an unwinding process. A decorative impregnate and an overlay impregnate were then applied with the usual resin and moisture content.

This structure was run through the system at a speed of 9.5 m/min with a structuring paper on the upper side and a pergamin (60 g/m²) on the underside. The pressing temperature was 180° C., the pressing pressure 60 kg/cm². No resin leakage was observed at the edge behind the press. The resulting laminate was trimmed and rolled up.

The laminate was then tested in accordance with DIN EN 438 in comparison with a laminate produced with impregnated NKP for a number of important parameters (water vapor test, scratch test). No differences were found between the two laminates. To test the laminate bond, storage in hot water (2 h) was carried out. No blistering or delamination was observed. The water absorption was 5.5%. When testing the impact resistance in accordance with DIN EN 438-Part 20 “small ball”, a value of 22 N was determined for the laminate without glass fleece and a value of 29 N for the laminate with glass fleece.

### Example 6

An 80 g/m² NKP (width: 1340 mm) was unwound from a roll on a CPL system. With the help of a moistening system, approx. 10 g water/m² was sprayed onto the kraft paper (top side). Immediately before the press, a mixture of phenolic and melamine resin was sprinkled onto the NKP.

The ratio between phenolic and melamine resin was 3 to 2. The resins were mixed in a mixing device and then fed to the spreading device. The application quantity was 68 g resin mixture/m² (resin application: 85% based on two NKP).

The spreader was adjusted so that the web was not sprinkled with resin powder on the outer two centimetres on both sides. A 0.2 mm aluminum foil primed on both sides was unrolled onto the kraft paper to reduce water vapor permeability and 68 g/m² resin was also sprinkled on top. A second NKP layer of the same grammage was applied to the aluminum foil by unwinding. A decorative impregnate and an overlay impregnate were then applied with the usual resin and moisture content.

This structure was run through the system at a speed of 9.5 m/min with a structuring paper on the upper side and a pergamin (60 g/m²) on the underside. The pressing temperature was 180° C., the pressing pressure 60 kg/cm². No resin leakage was observed at the edge behind the press. The resulting laminate was trimmed and rolled up.

### Example 7

An 80 g/m² NKP (width: 1340 mm) was unwound from a roll on a CPL system. With the help of a moistening system, approx. 10 g water/m² was sprayed onto the kraft paper (top side).

A mixture of phenolic and melamine resin was spread onto the NKP immediately before the press. The ratio between phenolic and melamine resin was 3 to 2. The resins were mixed in a mixing device and then fed to the spreading device.

The application quantity was 210 g resin mixture/m² (resin application: 85% based on two NKP). The spreader was adjusted so that the outer two centimeters of the web were not sprinkled with resin powder on both sides. An oak veneer (thickness: 0.5 mm) measuring 1400×1340 mm was applied to the kraft paper. An overlay impregnate with the usual resin and moisture content was then applied.

This structure was created with a structure paper on the upper side and a pergamin (60 g/m²) on the underside was fed through the system at a speed of 9.5 m/min. The pressing temperature was 180° C. and the pressing pressure was 60 kg/cm². The resulting laminate showed no delamination. The transparency was good.

1. A method of producing a laminate comprising at least one kraft paper layer, comprising:
providing at least one raw or non-impregnated kraft paper layer,
applying at least a first layer of at least one powdered resin to at least one side of the kraft paper layer,
placing at least one further layer of paper on the side of the kraft paper layer sprinkled with the powdered resin, and:
pressing the layer structure.

2. The method according to claim 1, wherein in the at least one raw kraft paper layer has a weight of 50 to 200 g/m².

3. The method according to claim 1, wherein the at least one raw kraft paper layer is moistened before sprinkling with the powdered resin.

4. The method according to claim 3, wherein water is applied to a raw kraft paper layer in an amount of 10 g water/m² to 40 g water/m² for moistening.

5. The method according to claim 1, wherein the resin in powder form is a formaldehyde resin.

6. The method according to claim 1, wherein the powdered resin is applied to the at least one kraft paper layer in an amount of 50 to 350 g/m².

7. The method according to claim 1, wherein the at least one further paper layer to be applied is a kraft paper layer, a decor paper layer or an overlay paper layer.

8. The method according to claim 1, wherein at least one layer of a coating material is first applied to the side of the raw kraft paper layer sprinkled with the powdery resin, followed by the at least one further paper layer.

9. The method according to claim 8, wherein a veneer layer, a graphite-containing paper, plastic film, aluminium foil, non-woven material and other fabric materials are used as the coating material layer.

10. The method according to claim 1, wherein the layered structure of raw kraft paper layer and at least one further paper layer is pressed with at least one structuring paper (placed on the at least one further paper layer on the upper side of the layering) and at least one transparent paper (on the lower side of the layering).

11. The method according to claim 1, wherein an additive is added to the powdered resin.

12. The method according to claim 1, the layer structure comprising the side of the raw kraft paper layer sprinkled with the powdery resin, at least one further paper layer, decor paper layer and/or overlay paper layer.

13. The laminate-producible in a process according to claim 1, comprising
at least one decorative paper layer, at least two kraft paper layers and at least one transparent paper, wherein at least one flame retardant is provided between the two kraft paper layers, or
at least one overlay paper layer, at least one decor paper layer, at least two kraft paper layers, at least one layer of a coating material and at least one transparent paper, or
at least one overlay paper layer, at least one kraft paper layer, at least one layer of a coating material and at least one transparent paper.

14-15. (canceled)

16. The method according to claim 2, wherein the at least one raw kraft paper layer has a weight of 80 to 170 g/m².

17. The method according to claim 4, wherein water is applied to a raw kraft paper layer in an amount of 10 to 20 g water/m² for moistening.

18. The method according to claim 5, wherein the resin in powder form is a melamine-formaldehyde resin or a phenol-formaldehyde resin or a mixture of a melamine-formaldehyde resin and a phenol-formaldehyde resin.

19. The method according to claim 6, wherein the powdered resin is applied to the at least one kraft paper layer in an amount of 100 to 300 g/m².

20. The method according to claim 11, wherein a flame retardant is added to the powdered resin.
